(19) United States
(12) Patent Application Publication
(10) Pub. No.: US 2011/0184880 A1
(43) Pub. Date: Jul. 28, 2011

(54) Subscription Renewals for Digital Content

(76) Inventors: David Lawrence Neumann, Lake Oswego, OR (US); Payam Mirrashidi, San Francisco, CA (US)

(21) Appl. No.: 12/694,206

(22) Filed: Jan. 26, 2010

(51) Int. Cl. G06Q 50/00; G06F 15/16; G06Q 10/00; G06Q 30/00

(52) U.S. Cl. 705/344; 709/203; 709/206

(57) ABSTRACT

Subscriptions for digital products including digital content are disclosed. A subscription for a digital product can provide digital content to subscribers for a period of time. In one embodiment, a subscription for a digital product can be purchased from an online store, and then a subscriber can receive digital content associated with the subscription. The subscription may require renewal if the subscription is to be continued. A subscription server can be provided to manage renewal of subscriptions, including payment of subscription renewal fees, so that subscriptions can be renewed and thus continued. Receipts for payments can be electronically distributed so that, upon renewal, digital content providers for subscriptions can verify that a given subscriber has renewed a particular subscription for a digital product.

### BACKGROUND OF THE INVENTION

1. Field of the Invention

The invention relates to subscriptions for digital content and, more particularly, to network-based renewal of subscriptions for digital content.

2. Description of the Related Art

Today, it is common for users to access on-line media repositories to purchase songs on-line. Recently, on-line media repositories have supported distribution of videos, such as movies or television shows, games and application programs. The typical interaction with an on-line media repository is that a user will browse the on-line media repository, select one or more digital asset items to be purchased or otherwise acquired, and then receive electronic delivery of the digital asset items over a network. Even more recently, on-line media repositories now provide a “Season Pass” which can be purchased. For example, a “Season Pass” might permit a subscriber to access all the episodes of a particular television show that take place in a given season. Upon purchase of a “Season Pass” by a subscriber, the subscriber can be delivered a predetermined number of episodes of a television show as they become available during a television show's season. One example of an on-line media repository is an on-line media store, such as the iTunes Music Server® provided by Apple Inc.

Although the “Season Pass” is a subscription purchase, the subscription is limited to a season and payment is paid in full for the entire season. Unfortunately, however, subscriptions can be periodic and not limited to a specific duration (e.g., season) or quantity (e.g., number of episodes). For subscriptions that are periodic and not limited in duration or quantity, payment for continued access to the subscription also tends to be periodic. Accordingly, to provide more general support for subscriptions, there is a need for improved approaches to facilitate management of subscriptions to digital content.

### SUMMARY

The invention pertains to subscriptions for digital products including digital content. A subscription for a digital product can provide digital content to subscribers for a period of time. In one embodiment, a subscription for a digital product can be purchased from an online store, and then a subscriber can receive digital content associated with the subscription. The subscription may require renewal if the subscription is to be continued. A subscription server can be provided to manage renewal of subscriptions, including payment of subscription renewal fees, so that subscriptions can be renewed and thus continued. Receipts for payments can be electronically distributed so that, upon renewal, digital content providers for subscriptions can verify that a given subscriber has renewed a particular subscription for a digital product.

In general, the invention can be implemented in numerous ways, including as a method, system, device, or apparatus (including graphical user interface or computer readable medium). Several embodiments of the invention are discussed below.

According to one embodiment, a computer-implemented method for renewing a subscription to digital content can operate to determine whether a previously acquired subscription to digital content needs to be renewed. The method can also determine whether renewal of the subscription is authorized for renewal. If the subscription is authorized for renewal, purchase of a subscription renewal for the subscription can be performed, and a renewal receipt can be made available.

According to another embodiment, a computer-implemented method for renewing a subscription to digital content can obtain an existing expiration date for the subscription to digital content. The method can also determine whether the subscription to digital content needs to be renewed based on the current expiration date. In addition, the method can determine whether renewal of the subscription is authorized for renewal. A subscription renewal for the subscription can then be initiated, provided the subscription to digital content needs to be renewed and provided renewal of the subscription is authorized. The method can also determine whether the purchase of the subscription renewal has been successful. A renewal receipt can be rendered available if the purchase of the subscription renewal is determined to be successful. The renewal receipt can have a new expiration date that is later than the existing expiration date.

According to another embodiment, a computer readable medium including at least computer program code tangibly stored thereon for renewing a subscription to digital content, can include at least: computer program code for determining whether a previously acquired subscription to digital content needs to be renewed; computer program code for determining whether renewal of the subscription is authorized for renewal; computer program code for processing purchase of a subscription renewal for the subscription being renewed if determined that the subscription is authorized for renewal; and computer program code for rendering a renewal receipt available.

According to another embodiment, a server computer can, for example, include at least one storage device and at least one processor. The at least one storage device can store computer program code and subscription management data. The subscription management data can pertain to a plurality of customers that have purchased access to subscriptions to subscription content. The at least one processor can, for example, be configured to (i) determine whether a previously acquired subscription to digital content needs to be renewed for a particular customer based on the subscription management data; (ii) determine whether renewal of the subscription is authorized by the particular customer based on the subscription management data; (iii) initiate purchase of a subscription renewal for the subscription being renewed on behalf of the particular customer if determined that the subscription is authorized for renewal; and (iv) produce a renewal receipt for the subscription renewal following successful purchase of the subscription renewal for the subscription being renewed on behalf of the particular customer.

According to another embodiment, a computer-implemented method for acquiring digital content associated with a subscription to digital content can determine whether a previously acquired subscription to digital content needs to be renewed. A renewal receipt can be received from an online commerce server. The renewal receipt authorizes a recipient to receive subscription content for a predetermined period of time. The method can also subsequently send the renewal receipt to a subscription content server. The method can thereafter, to the extent authorized by the renewal receipt, receive digital content associated with the subscription that has been successfully renewed.

According to another embodiment, a computer readable medium including at least computer program code tangibly stored thereon for acquiring digital content associated with a subscription to digital content, can include at least: computer program code for determining whether a previously acquired subscription to digital content needs to be renewed; computer program code for receiving a renewal receipt from an online commerce server, the renewal receipt authorizing a recipient to receive subscription content for a predetermined period of time; computer program code for sending the renewal receipt to a subscription content server; and computer program code for receiving, within the predetermined period of time authorized by the renewal receipt, digital content associated with the subscription that has been successfully renewed.

According to still another embodiment, a computer-implemented method for distributing digital content associated with a subscription to digital content can receive a renewal receipt from a client device. The renewal receipt authorizes the client device or its user to receive subscription content for a predetermined period of time. The method can further verify the renewal receipt received from the client device with an online commerce server that originated the renewal receipt. The method can also enable digital content associated with the subscription to be provided to the client device if the renewal receipt is verified by the online commerce server.

Other aspects and advantages of the invention or embodiments thereof will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a subscription distribution system according to one embodiment.

FIG. 2 is a block diagram of a server device according to one embodiment.

FIG. 3 illustrates a flow diagram of a subscription purchase process according to one embodiment.

FIG. 4 illustrates a flow diagram of a server pre-renewal process according to one embodiment.

FIG. 5 illustrates a flow diagram of a server renewal process according to one embodiment.

FIG. 6 illustrates a flow diagram of a renewal receipt retrieval process according to one embodiment.

FIG. 7 illustrates a flow diagram of the subscription content retrieval process according to one embodiment.

FIGS. 8A and 8B illustrate a flow diagram of a subscription content access process according to one embodiment.

FIG. 9 shows an exemplary computer system.

### DETAILED DESCRIPTION OF EMBODIMENTS OF THE INVENTION

The invention pertains to subscriptions for digital products including digital content. A subscription for a digital product can provide digital content to subscribers for a period of time. In one embodiment, a subscription for a digital product can be purchased from an online store, and then a subscriber can receive digital content associated with the subscription. The subscription may require renewal if the subscription is to be continued. A subscription server can be provided to manage renewal of subscriptions, including payment of subscription renewal fees, so that subscriptions can be renewed and thus continued. Receipts for payments can be electronically distributed so that, upon renewal, digital content providers for subscriptions can verify that a given subscriber has renewed a particular subscription for a digital product.

The digital products provided as a subscription can be any type of digital data. For example, the digital data can be digital media assets (audio, graphic, video, etc.), games (or game levels or features), application programs (or program features), or periodicals (newspapers, magazines), articles, reports, presentations, shows, or blogs.

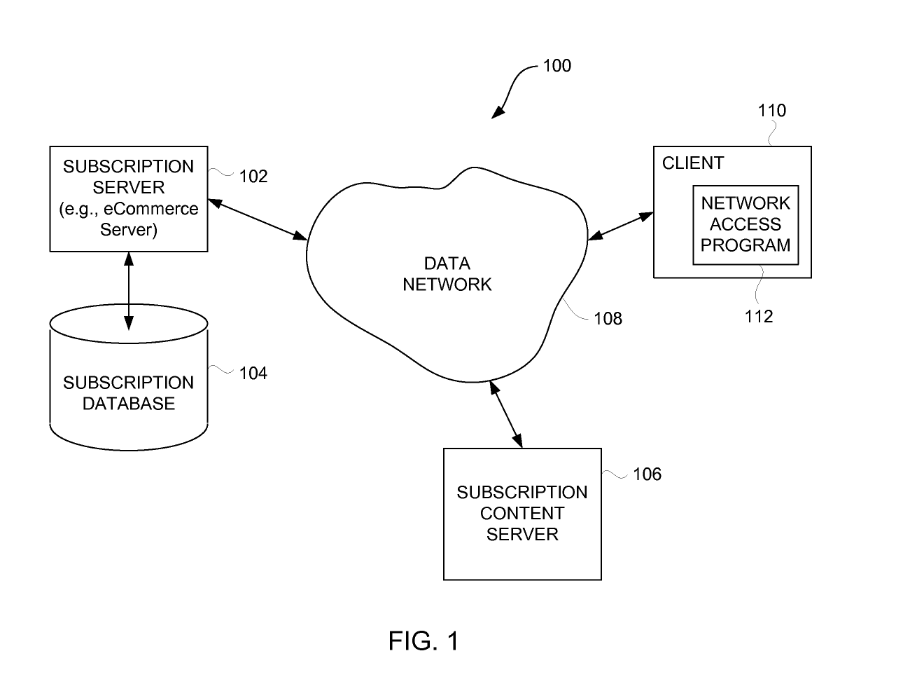

Embodiments of the invention are discussed below with reference to FIGS. 1-9. However, those skilled in the art will readily appreciate that the detailed description given herein with respect to these figures is for explanatory purposes as the invention extends beyond these limited embodiments.

FIG. 1 is a block diagram of a subscription distribution system 100 according to one embodiment. The subscription distribution system 100 includes a subscription server 102. The subscription server 102 provides an online access point for distribution of digital products, including subscriptions. For example, the subscription server 102 can also be referred to as an electronic commerce server. The subscription server 102 can host an online store that can be accessed to browse, search, manage and/or purchase subscriptions (or renewals thereof). The subscription server 102 can couple to and access a subscription database 104. The subscription database 104 can store subscription management data, such as purchase information, receipts for purchases, expiration information, and/or user accounts (or users).

The subscription distribution system 100 also includes or supports a client 110. Although FIG. 1 illustrates only the client 110, typically the subscription distribution system 100 would support a plurality of different clients. The client 110 can include a network access program 112. The network access program 112 is an application program (e.g., software application) that operates on the client 110, which is a computing device. One example of a suitable network access program is a network browser (e.g., Microsoft Explorer or Apple Safari). Another example of a suitable network access program is iTunes™ offered by Apple Inc., which also offers media management functionality. The client 110 can couple to the subscription server 102 through the data network 108. Hence, the client 110 can interact with the subscription server 102 to review, purchase and/or manage subscriptions to digital products.

In the subscription distribution system 100 shown in FIG. 1, the digital products, namely, subscriptions for digital content, are maintained at a subscription content server 106. The subscription content server 106 can be coupled to the data network. The subscription content server 106 can also access the subscription server 102 and/or the subscription database 104. The digital products can be available to be purchased from the subscription server 102.

The subscription distribution system 100 allows a user of the client 110 to utilize the network access program 112 to browse, search or sort through a plurality of digital products that can be purchased from the subscription server 102. In the event that the user of the network access program 112 desires to purchase a particular subscription, the user (via the network access program 114) and the subscription server 102 can engage in an online commerce transaction in which the user pays for access rights to the particular subscription. In one embodiment, a credit card associated with the user is credited for a purchase (or rental amount) of the particular subscription. After purchasing a subscription, digital content for the subscription can be made available to the user (subscriber), such as via the client 110.

After a user has purchased a subscription, the subscription might expire after a period (duration) of time. However, the subscription server 102 supports renewal of subscriptions. If the user performs or permits renewal of a particular subscription, the subscription server 102 can operate to process a fee payment for a renewal of the particular subscription and can also manage providing a receipt of such renewal to the appropriate client 110 and/or the subscription content server 106.

Upon purchasing a subscription to a particular digital product, the subscription server 102 permits the digital content for the particular digital product to be retrieved from the subscription content server 106 and then made accessible to the requesting client 110. The accessibility to the digital content of the particular digital product can be achieved by unlocking such digital content already resident on the requesting client 110. Alternatively, digital content of the particular digital product can be delivered, such as downloaded, from the subscription content server 106 to the requesting client 110 through the data network 108. In this regard, the subscription server 102 or some other delivery server (not shown) obtains the digital data corresponding to the particular digital product and downloads such digital data through the data network 108 to the client 110. The downloaded digital data can then be stored on the client 110. In one embodiment, the downloaded digital data is encrypted as received at the client 110 but is decrypted and then perhaps re-encrypted before being persistently stored on the client 110. Thereafter, the client 110 can utilize (e.g., execute) the digital data of the digital product at the client 110.

In one embodiment, the connections through the data network 108 between the subscription server 102 and the clients 110, 112 can be through secure connections, such as Secure Sockets Layer (SSL). In one implementation, the data network 108 can refer to one or more data networks, typically, high data-bandwidth networks, namely, wired networks, such as the Internet, Ethernet, gigabit Ethernet, and fiber optic, as well as wireless networks such as IEEE 802.11(a), (b) or (g) (WiFi), IEEE 802.16 (WiMax), and Ultra-Wide Band (UWB).

Although the subscription server 102, the subscription content server 106 and the subscription database 104 are shown in FIG. 1 as being separate components, it should be understood that any of these components can be combined into one or more apparatus. For example, the subscription content server 106 can be incorporated into the subscription server 102. As another example, the subscription database 104 can be incorporated into the subscription server 102 or the subscription content server 106. Also, for improved efficiency, certain data, such as subscription receipts, can be maintained in a more efficiently accessible data structure (e.g., cache).

The client device 110 can be any electronic device that is used by a user. The electronic device is, for example, a computing device having memory storage. The electronic device can also be a portable electronic device. Some examples of portable electronic devices include mobile telephones (e.g., cell phones), Personal Digital Assistants (PDAs), portable media players (e.g., MP3 players), notebook computers, netbook computers, electronic tablets (including tablet computers), e-book readers, portable gaming devices (including game players and game controllers), etc.

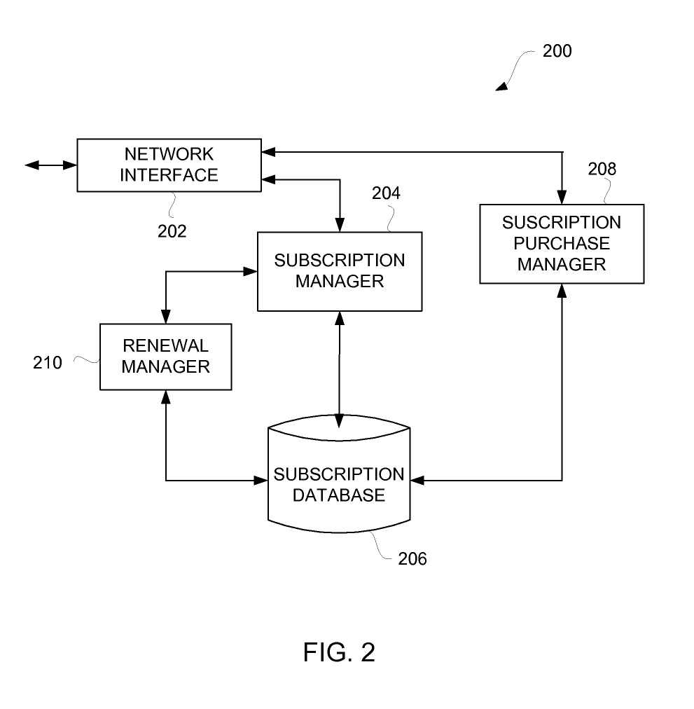

FIG. 2 is a block diagram of a server device 200 according to one embodiment. The server device 200 is, for example, suitable for use as at least a portion of the subscription server 102 illustrated in FIG. 1. The server device 200 supports management of subscriptions, including payment processing for renewal purchases. The server device 200 includes a network interface 202 that couples to a data network over which data can be exchanged with one or more client devices, server devices, or other computing devices. A subscription manager 204 is coupled to the network interface 202. The subscription manager 204 accesses a subscription database 206 to obtain information regarding one or more subscriptions. The subscription database 206 can include or couple to a finance database. The finance database can store records pertaining to financial transactions being provided at the server device 200. Here, subscription purchases and renewals thereof can be stored within the finance database.

The subscription manager 204 can receive and respond to subscription inquiries from requestors via the network interface 202. The server device 200 also includes a subscription purchase manager 208. The subscription purchase manager 208 is coupled to the network interface 202. When a requestor operating a client device requests purchase of a particular subscription, the request is transmitted to the network interface 202 via the data network. The network interface 202 directs the request to the subscription purchase manager 208. The subscription purchase manager 208 operates to a process the request to purchase the particular subscription. In doing so, the media purchase manager 208 can update subscription management data stored in the subscription database 206. In this regard, the subscription management data for a given requestor can specify at least a requestor identifying a subscription identifier, expiration date, price paid, and date that the requestor purchased the particular subscription. Still further, the server device 200 can include a renewal manager 210. The renewal manager 210 couples to the media asset manager 204 and the subscription database 206. The renewal manager 210 can perform the various tasks associated with renewal of subscriptions. On renewal, the subscription management data in the subscription database 206 can be updated to reflect the renewal. For example, price, purchase date and/or expiration date for the renewal can be recorded in the subscription database 206. The subscription management data stored in the subscription database 206 can also include one or more receipts that specify those users (e.g., account holders) that have purchased subscriptions as well as renewals of such subscriptions.

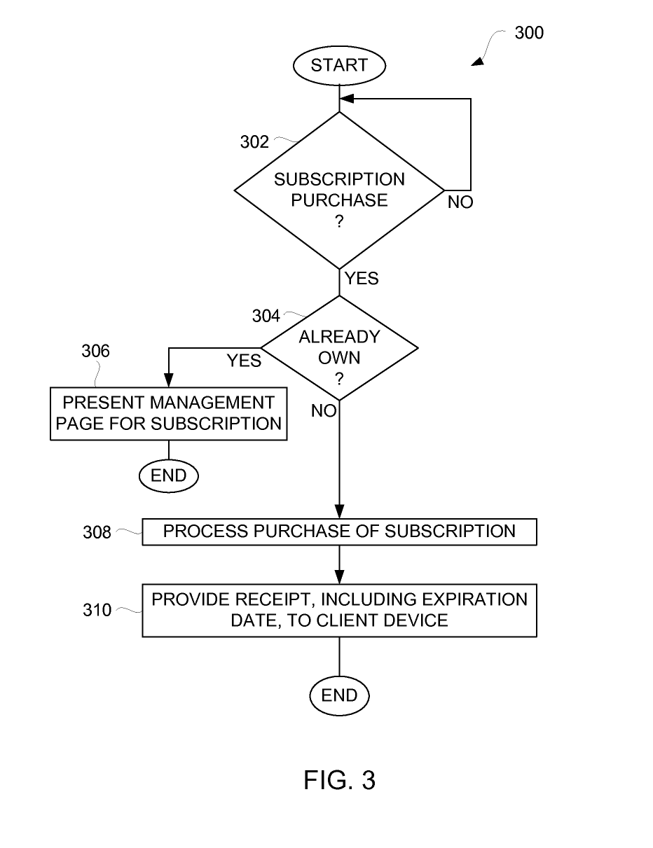

FIG. 3 illustrates a flow diagram of a subscription purchase process 300 according to one embodiment. The subscription purchase process 300 can be performed by a server computer (server), such as the subscription server 102 illustrated in FIG. 1.

The subscription purchase process 300 can begin with a decision 302 that determines whether a subscription purchase has been requested. When the decision 302 determines that a subscription purchase has not been requested, the subscription purchase process 300 awaits such a request. In other words, the subscription purchase process 300 can be effectively invoked once a subscription purchase request has been received. In any event, once the decision 302 determines that a subscription purchase request has been received, a decision 304 can determine whether the particular subscription being purchased is already owned by the requestor.

When the decision 304 determines that the requestor already owns the particular subscription, a management page for the subscription can be presented 306 to the requestor. From the management page, the requestor can manipulate one or more user settings associated with the subscription. As an example, one of the user settings can pertain to enabling or disabling automatic renewal of the subscription. Following block 306, the subscription purchase process 300 can end without purchase of the particular subscription.

On the other hand, when the decision 304 determines that the requestor does not already own the particular subscription, purchase of the particular subscription can be processed 308. The processing 308 of the purchase of the subscription can involve payment of subscription purchase fee to a subscription provider or distributor. Following the purchase of the particular subscription, a receipt can be provided 310 to a client device associated with the requestor. The receipt can include an expiration date, i.e., an indication of when the subscription expires (e.g., duration, time, or date). Typically, a client device would be utilized by the requestor to make the request for the subscription purchase. In exchange for payment for access to the subscription, the client device can be provided with a receipt that allows the client device (or requestor) to receive subscription content pertaining to the subscription. The receipt is an electronic document, such as a markup language document, that can specify at least a subscriber identifier, a subscription identifier and an expiration indication. Following the block 310, the subscription purchase process 300 can end.

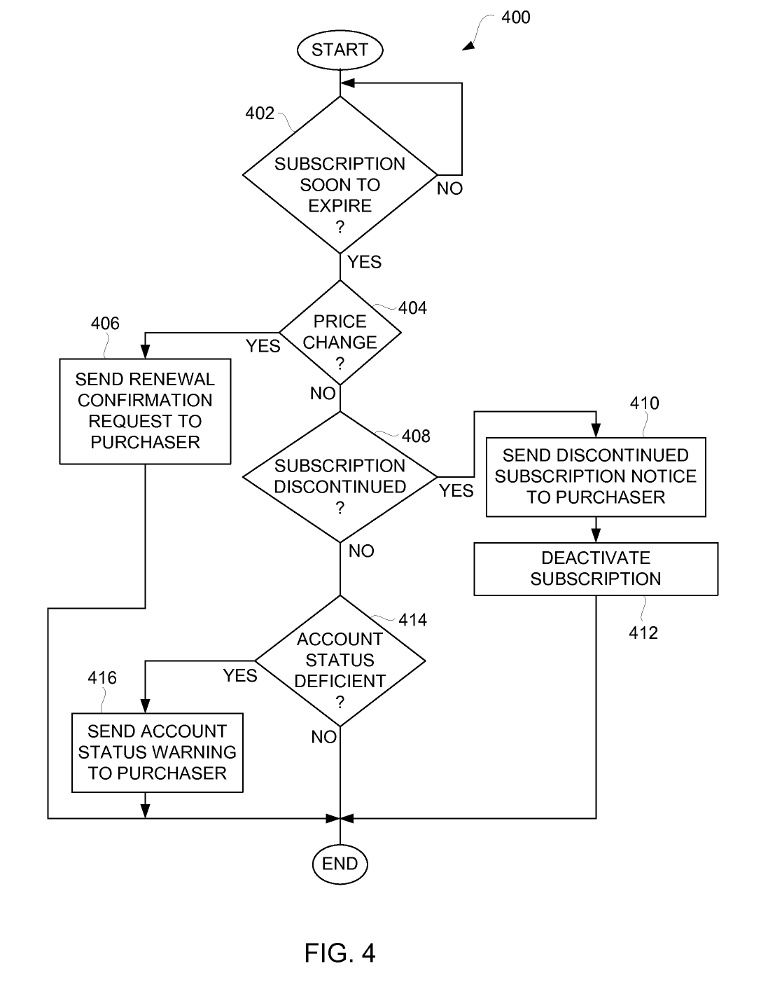

FIG. 4 illustrates a flow diagram of a server pre-renewal process 400 according to one embodiment. The server pre-renewal process 400 can be performed by a server computer (server), such as the subscription server 102 illustrated in FIG. 1.

In general, the server pre-renewal process 400 can be performed prior to an attempt to renew a subscription. Typically, the pre-renewal process would be performed several days prior to the expiration of a subscription so that pre-renewal processing can be performed to facilitate subsequent renewal of the subscription prior to or on expiration of the subscription.

The server pre-renewal process 400 can begin with a decision 402 that determines whether a subscription is soon to expire. For example, a subscription can be considered “soon to expire” if there is less then a predetermined amount of time (e.g., days, hours, seconds, etc.) before expiration. The predetermined amount of time can vary depending upon implementation. As one example, the predetermined amount of time can be between three (3) and ten (10) days in certain embodiments. When the decision 402 determines that a subscription is not soon to expire, the server pre-renewal process 400 can wait until a subscription is soon to expire.

Once the decision 402 determines that a subscription is soon to expire, a decision 404 can determine whether a price change has occurred. For example, a price change can occur if the price for the renewal has changed since initially purchased (or since last renewed). When the decision 404 determines that the price has changed, a renewal confirmation request can be sent 406 to the purchaser of the subscription that will soon need to be renewed. The renewal confirmation request can serve to request the purchaser to confirm her desire to renew the subscription even though the price has changed.

On the other hand, when the decision 404 determines that a price change has not occurred, a decision 408 can determine whether the subscription has been discontinued. When the decision 408 determines that the subscription has been discontinued, a discontinued subscription notice can be sent 410 to the purchaser. The discontinued subscription notice can inform the purchaser that the subscription they previously purchased is being discontinued so that any renewal thereof is unavailable. Additionally, in such case, the subscription can be marked as deactivated 412 so that additional renewal processing need not be performed.

Alternatively, when the decision 408 determines that the subscription has not been discontinued, a decision 414 can determine whether an account status is deficient for the purchaser seeking to renew the previously purchased subscription. When the account status for the purchaser is deemed to be deficient, an account status warning can be sent 416 to the purchaser. For example, if the account associated with the purchaser has credit card information for a now-expired credit card, the account status can be considered deficient.

Following the boxes 406, 412, 414 (when account status is not deficient), and 416, the server pre-renewal process 400 can end. It should be understood that the server pre-renewal process 400 can perform other pre-renewal processing besides price, discontinued and account status processing to assist with the renewal of the subscription soon to expire.

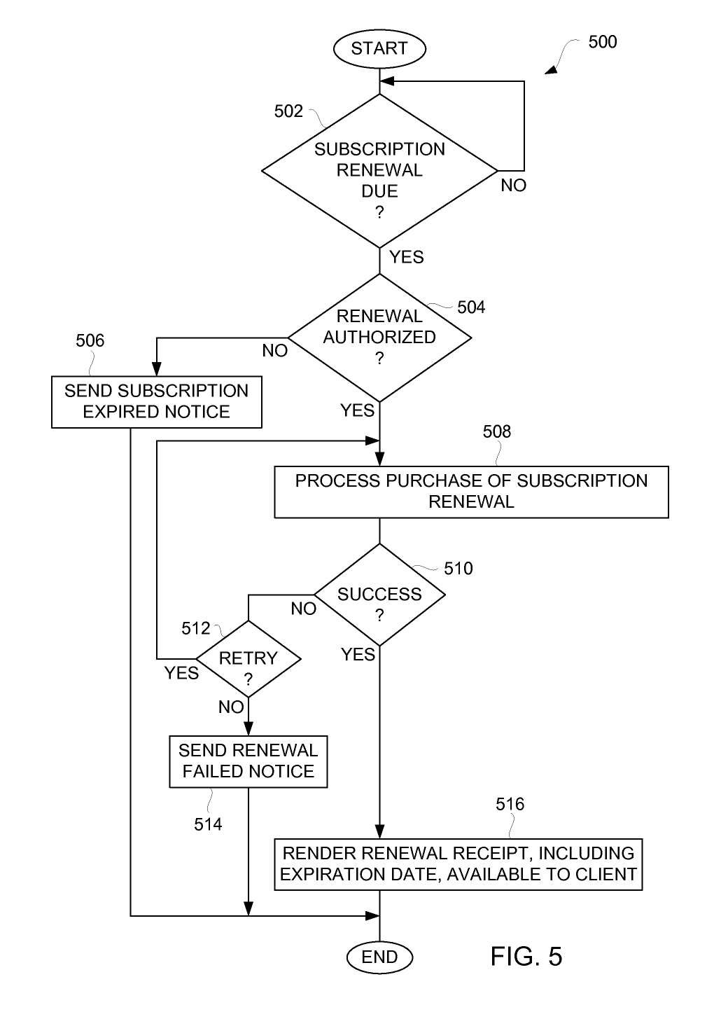

FIG. 5 illustrates a flow diagram of a server renewal process 500 according to one embodiment. The server renewal process 500 can, for example, be performed by a server computer (server), such as the subscription server 102 illustrated in FIG. 1.

The server renewal process 500 can begin with a decision 502 that determines whether a subscription renewal is due. When the decision 502 determines that a subscription renewal is not due, then the server renewal process 500 waits until a subscription renewal is due. In other words, the server renewal process 500 can be invoked once a subscription renewal is due.

Once the decision 502 determines that a subscription renewal is due, the server renewal process 500 can continue to provide other processing. In particular, a decision 504 can determine whether renewal of the subscription is authorized by the subscriber (requestor). When the decision 504 determines that renewal is not authorized by the subscriber, a subscription expired notice can be sent 506 to the subscriber. In this case, the subscription is not renewed for the subscriber; hence, the subscriber is advised that the subscription has or will soon expire. Upon receive the subscription expired notice, the subscriber can take action to authorize the renewal of the subscription if so desired. For example, the subscription expired notice can include a link (e.g., hyperlink) to a management area (e.g., webpage or application screen) where the subscriber (requestor) can provide a user indication (e.g., user renewal setting) that requests or declines renewal of the subscription.

On the other hand, when the decision 504 determines that renewal is authorized, purchase of a subscription renewal can be processed 508. The processing at block 508 can initiate purchase of the subscription renewal at a renewal price. A decision 510 can then determine whether the purchase of the subscription renewal has been successful. When the decision 510 determines that the purchase of the subscription renewal has not been successful, a decision 512 can determine whether to retry the purchase processing. When the decision 512 determines that retry of the purchase processing should be performed, the server renewal process 500 can return to repeat the block 508 and subsequent blocks so that purchase processing for the subscription renewal can be again attempted. Alternatively, when the decision 512 determines that retry of the purchase processing should not be performed, a renewal failed notice is send 514 to the subscriber. The renewal failed notice informs the subscriber that the attempt to renew the subscription has failed. The renewal failed notice can provide information of the nature or specifics of the failure.

On the other hand, when the decision 510 determines that the purchase of the subscription renewal has been successful, a renewal receipt can be rendered 516 and made available to the client device. The renewal receipt can include a renewal period (duration) until the renewal receipt expires. Here, the renewal receipt is a receipt that contains information that can indicate that the requestor has purchased a subscription renewal and is thus entitled to receive subscription content at least up it expires. Following the blocks 506, 514 and 516, the server renewal process 500 is complete and ends.

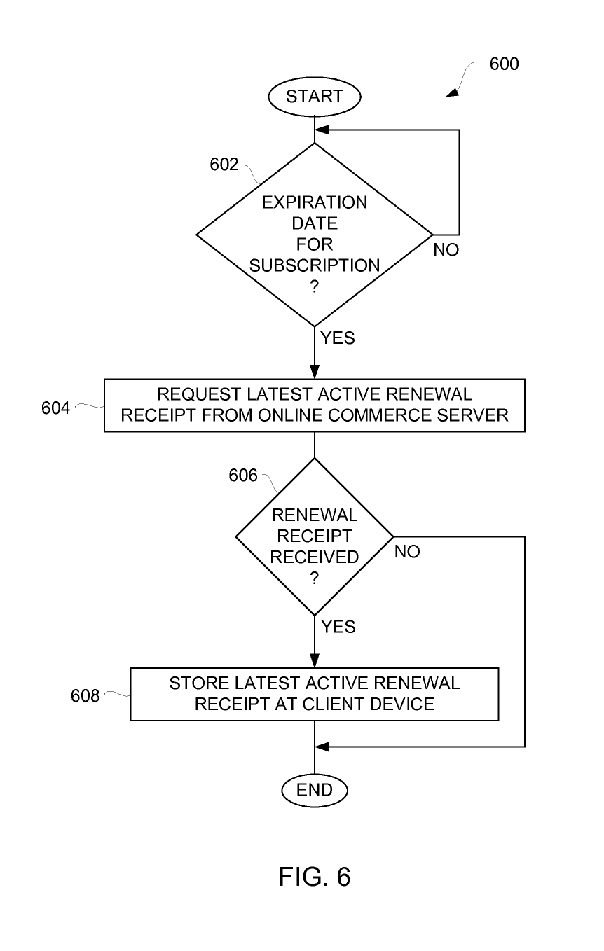

FIG. 6 illustrates a flow diagram of a renewal receipt retrieval process 600 according to one embodiment. The renewal receipt retrieval process 600 is, for example, performed by a client device according to one embodiment. For example, the client device can be the client 110 illustrated in FIG. 1. In general, a renewal receipt resident at a server computer can be accessed and retrieved by a client device. The renewal receipt is proof that the client device (and/or its user or account owner) is entitled to receive subscription content to the extent of the renewal evidenced by the renewal receipt.

The renewal receipt retrieval process 600 can begin with a decision 602 that determines whether an expiration date for the subscription has been reached, such that the subscription is to expire. When the decision 602 determines that the expiration date for the subscription has not been reached, the renewal receipt retrieval process 600 need not be performed.

On the other hand, when the decision 602 determines that the expiration date for the subscription has been reached, a latest active renewal receipt can be requested 604 from an online commerce server, such as the subscription server 102 illustrated in FIG. 1. The latest active renewal receipt is maintained at the online commerce server, such as by a renewal manager (e.g., renewal manager 210), with subsequent renewal receipts being provided as subscriptions are renewed. Accordingly, when the decision 602 determines that the expiration date for the subscription has not been reached, a latest active renewal receipt can be requested 604 from the online commerce server. The latest active renewal receipt is a receipt provided by the online commerce server and serves to provide evidence that the corresponding purchaser is entitled to receive subscription content so long as the renewal receipt is not expired.

After the latest active renewal receipt has been received at the client device, a decision 606 can determine whether the renewal receipt has been received. Once the decision 606 determines that the renewal receipt has been received, the latest active retrieval receipt can be stored 608 at the client device. Alternatively, when the decision 606 determines that renewal receipt has not been received, the block 608 can be bypassed. Following the block 608 or its being bypassed, the renewal receipt retrieval process 600 can end.

Although the renewal receipt retrieval process 600 is performed at or temporally proximate to expiration of a subscription, it should be noted that the renewal receipt retrieval process 600 can be performed whenever a client device is desirous of receiving a newer renewal receipt from a remote server that manages and maintains renewal receipts for subscribers to subscriptions.

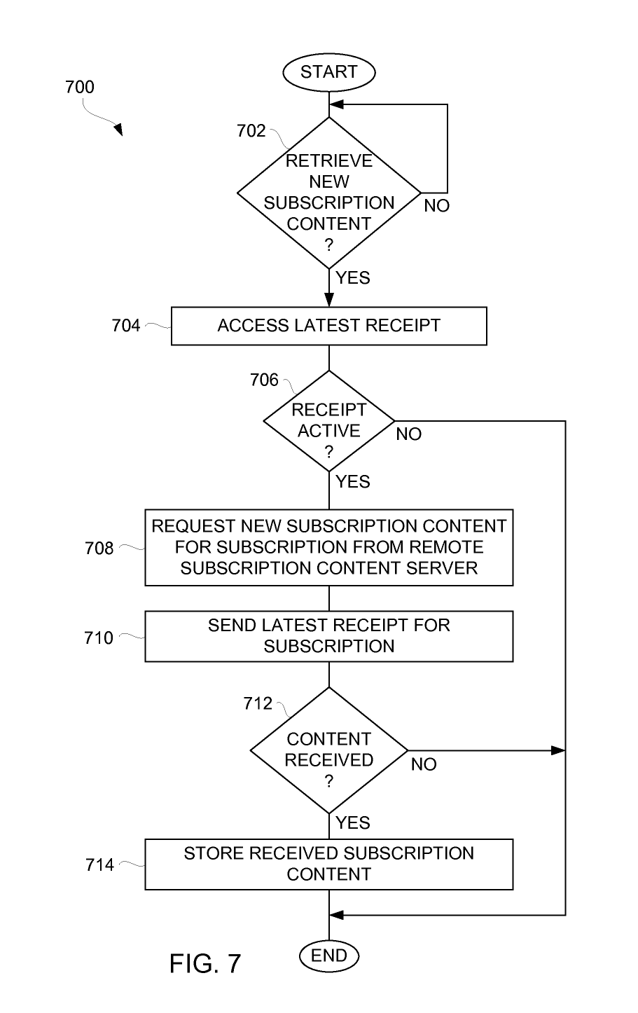

FIG. 7 illustrates a flow diagram of the subscription content retrieval process 700 according to one embodiment. The subscription content retrieval process 700 can, for example can be performed on a client device. For example, the client device can be the client 110.

The subscription content retrieval process 700 can begin with a decision 702 that determines whether new subscription content for a subscription should be retrieved. For example, an application program operating on the client device can periodically cause retrieval of new subscription content. Typically, subscription content can be made available according to a periodic schedule known by the application program. Hence, at the appropriate times (hourly, daily, weekly, monthly, etc.), the application program can induce the subscription content retrieval process 700 so that new subscription content, to the extent available, can be retrieved. When the decision 702 determines that new subscription content should not be retrieved, the subscription content material process 700 can await the need to retrieve new subscription content.

Once the decision 702 determines that new subscription content should be retrieved, a latest receipt associated with the subscription can be accessed 704. In one embodiment, the latest receipt resides on the client device and can be accessed by the subscription content retrieval process 700. For example, the latest receipt residing on the client device can pertain to a latest renewal receipt that could have been acquired using the renewal receipt retrieval process 600 illustrated in FIG. 6.

After the latest receipt has been accessed 704, a decision 706 can determine whether the receipt is active. For example, if the receipt has already expired, the receipt is deemed not active. Also, the receipt can be cryptographically signed, and the receipt can also be deemed invalid (and thus not active) if the cryptographic signature is not correct. When the decision 706 determines that the receipt is not active, the subscription content retrieval process 700 can end without retrieving any subscription content.

On the other hand, when the decision 706 determines that the receipt is active, new subscription content for the particular subscription can be requested 708 from a remote subscription content server. The remote subscription content server can be affiliated with an application program operating on the client device that is initiating retrieval of subscription content. For example, the remote subscription content server can be the subscription content server 106 illustrated in FIG. 1. Additionally, the subscription content retrieval process 700 can send 710 the latest receipt for the subscription that is available at the client device to the remote subscription content server. In one embodiment, the latest receipt can be sent together with the request for the new subscription content. In another embodiment, the latest receipt can be sent separately from the request for in the new subscription content.

Next, a decision 712 can determine whether subscription content has been received in response to the request for the new subscription content. When the decision 712 determines that the requested subscription content has not been received, the subscription content retrieval process 700 can end. On the other hand, when the decision 712 determines that the new subscription content that has been requested has been received, the received subscription content can be stored 714 back the client device. Once the received subscription content is stored 714 at the client device, the subscription content can be utilized by the client device, namely, an application program operating on the client device. Following the block 714, the subscription content retrieval process 700 can end.

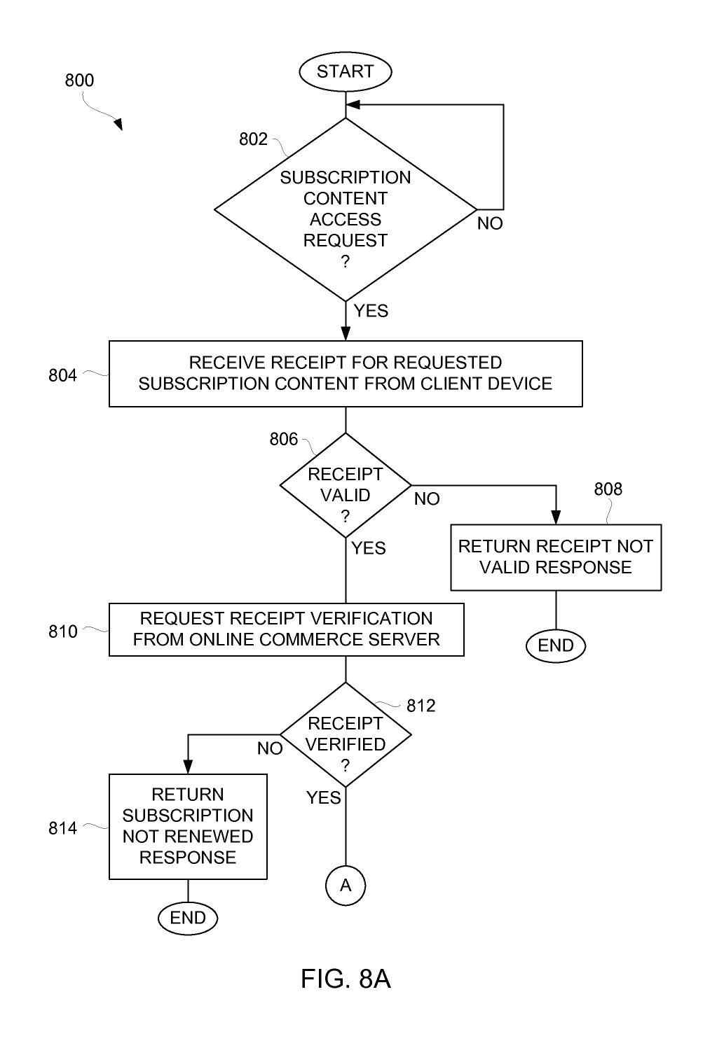

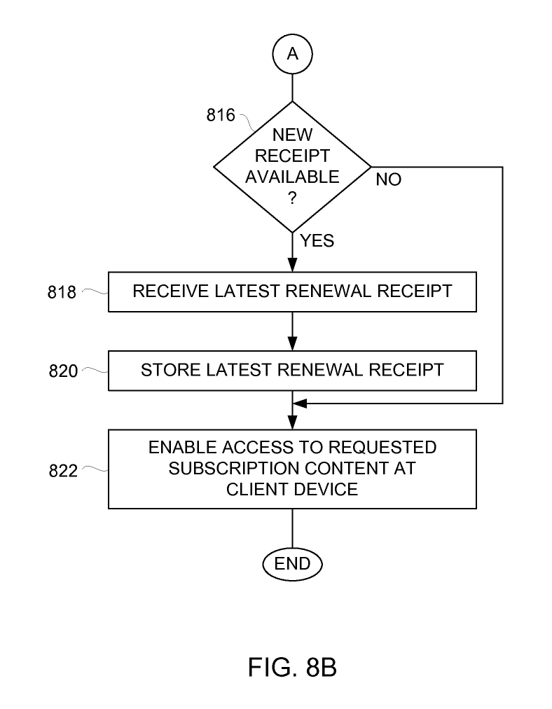

FIGS. 8A and 8B illustrate a flow diagram of a subscription content access process 800 according to one embodiment. The subscription content access process 800 can be performed by server computer. For example, the server computer can be the subscription content server 106 illustrated in FIG. 1.

The subscription content access process 800 can begin with a decision 802 that determines whether a subscription content access request has been received. When the decision 802 determines that a subscription content access request has not been received, the subscription content access process 800 awaits such a request. In other words, the subscription content access process 800 can effectively be invoked when a subscription content access request has been received. Typically, the subscription content access request will be received from a client device performing processing such as in block 708 of the subscription content retrieval process 700 illustrated in FIG. 7.

Once the decision 802 determines that a subscription content access request has been received, the subscription content access process 800 can perform processing in response to the subscription content access request. In particular, a receipt for requested subscription content can be received 804 from the client device. As previously noted, the receipt can be part of the subscription content access request or can be separately provided.

Next, a decision 806 determines whether the receipt that has been received is valid. The validation of the receipt can involve a digital signature check as well as an expiration check. When the decision 806 determines that the receipt is not valid, a receipt not valid response can be returned 808 to the client device. Following the block 808, the subscription content access process 800 can end since they subscriber has not tendered a valid receipt and thus is not permitted to access subscription content.

On the other hand, when the decision 806 determines that the receipt is valid, receipt verification can be requested 810 from an online commerce server. The online commerce server is, for example, the subscription server 102 illustrated in FIG. 1. Next, a decision 812 can determine whether the receipt has been verified by the online commerce server. Here, the server computer performing the subscription content access process 800 can receive from the online commerce server an indication whether the receipt has been verified. When the decision 812 determines that the receipt has not been verified, a subscription not renewed response can be returned 814 to the client device. Here, although the client device had a valid receipt, the online commerce server has informed the server computer that the receipt is not able to be verified. In other words, the receipt is bad and the client device is thus not entitled to receive subscription content. The receipt can be considered invalid for any of a number of reasons. As one example, the receipt can be invalidated prior to its expiration if the subscription for the requestor (subscriber) has been canceled (or purchase money refunded) since the receipt was produced. As another example, the receipt can be invalidated if deemed fraudulent. Following the block 814, the subscription content access process 800 can end since they subscriber has been determined not eligible to receive subscription content.

Alternatively, when the decision 812 determines that the receipt has been verified, a decision 816 can determine whether a newer receipt is available at the online commerce server. When the decision 816 determines that a newer receipt is available from the online commerce server, the latest renewal receipt can be received 808 from the online commerce server. In addition, the latest renewal receipt can be stored 820 at the server computer. If, however, the decision 816 determines that the newer receipt is not available, the blocks 818 and 820 can be bypassed.

Following the block 820 or its being bypassed, access to the requested subscription content at the client device can be enabled 822. Once the access to the requested subscription content has been enabled 822, the client device can access the requested subscription content in any of a variety of different ways depending upon implementation. For example, the client device could have the requested subscription content “unlocked” in cases where the subscription content is previously stored on the client device in a “locked” condition. As another example, the client device could download the requested subscription content from the server computer. The download could occur immediately following block 822 or could be deferred until a more suitable time. Following the block 822, the subscription content access process 800 can end.

In another embodiment, the server computer can itself verify a renewal receipt without having to request receipt verification from the online commerce server over a network connection. Advantageously, the server computer is able to verify a receipt faster and with less loading imposed on the online commerce server.

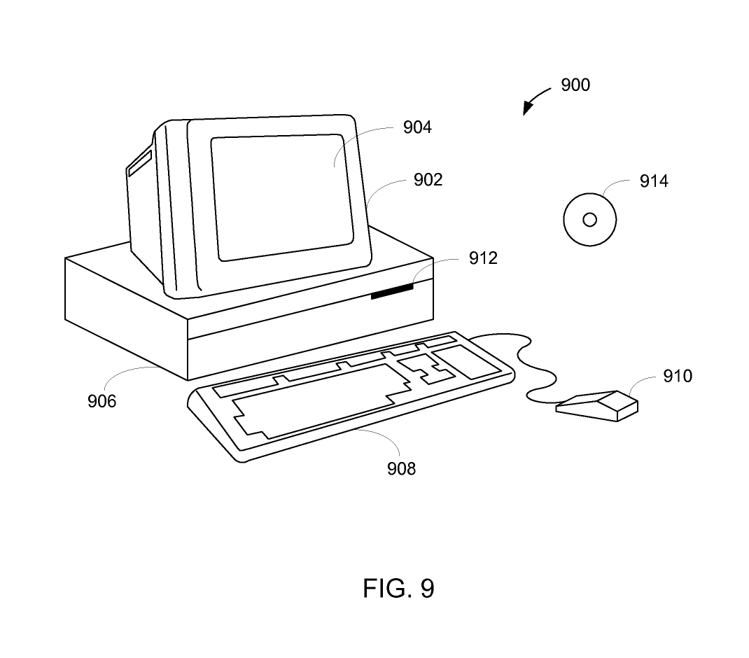

FIG. 9 shows an exemplary computer system 900. Although the client device need not be a personal computer, the client device can be implemented as the exemplary computer system 900 illustrated in FIG. 9. The computer system 900 includes a display monitor 902 having a single or multi-screen display 904 (or multiple displays), a cabinet 906, a keyboard 908, and a mouse 910. The cabinet 906 houses a processing unit (or processor), system memory and a hard drive (not shown). The cabinet 906 also houses a drive 912, such as a CD-ROM or floppy drive. The drive 912 can also be a removable hard drive, a Flash or EEPROM device, etc. Regardless, the drive 912 may be utilized to store and retrieve software programs incorporating computer code that implements some or all aspects of the invention, data for use with the invention, and the like. Although CD-ROM 914 is shown as an exemplary computer readable storage medium, other computer readable storage media including floppy disk, tape, Flash or EEPROM memory, memory card, system memory, and hard drive may be utilized. In one implementation, a software program for the computer system 900 is provided in the system memory, the hard drive, the CD-ROM 914 or other computer readable storage medium and serves to incorporate the computer code that implements some or all aspects of the invention.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for renewing a subscription to digital content, the method comprising:
determining, by a server computer, whether a previously acquired subscription to digital content needs to be renewed;
determining, by the server computer, whether renewal of the subscription is authorized for renewal;
processing, by the server computer, purchase of a subscription renewal for the subscription being renewed if determined that the subscription is authorized for renewal; and
rendering, by the server computer, a renewal receipt available.

2. A computer-implemented method as recited in claim 1, wherein the renewal receipt authorizing a recipient to receive subscription content for a predetermined period of time.

3. A computer-implemented method as recited in claim 1, wherein the renewal receipt is associated with a user account.

4. A computer-implemented method as recited in claim 3, wherein the method further comprises:
subsequently receiving a request for the renewal receipt from a client device associated with the user account; and
sending the renewal receipt to the client device.

5. A computer-implemented method as recited in claim 1, wherein the method further comprises:
sending a subscription expiration notice if determined that the subscription is not authorized for renewal.

6. A computer-implemented method as recited in claim 5, wherein the renewal receipt is associated with a user account, and
wherein the subscription expiration notice is sent to an email address associated with the user account.

7. A computer-implemented method as recited in claim 1, wherein the renewal receipt is associated with a user account, and
wherein the rendering of the renewal receipt available comprises placing the renewal receipt in a download queue associated with the user account.

8. A computer-implemented method as recited in claim 1, wherein the method further comprises:
determining whether a price for renewal of the subscription has changed since the subscription was purchased or last renewed; and
requiring confirmation of renewal at the changed price prior to processing purchase of the subscription renewal, if determined that the price for renewal of the subscription has changed since the subscription was purchased or last renewed.

9. A computer-implemented method as recited in claim 1, wherein the renewal receipt is associated with a user account, and wherein the method further comprises:
determining whether status of the user account is deficient; and
sending an account status notice advising of deficient account status if determined that the user account is deficient.

10. A computer-implemented method for renewing a subscription to digital content, the method comprising:
obtaining, by at least one server computer, an existing expiration date for the subscription to digital content;
determining, by the at least one server computer, whether the subscription to digital content needs to be renewed based on the current expiration date;
determining, by the at least one server computer, whether renewal of the subscription is authorized for renewal;
initiating, by the at least one server computer, purchase of a subscription renewal for the subscription being renewed, if determined that the subscription to digital content needs to be renewed and if determined that renewal of the subscription is authorized;
determining, by the at least one server computer, whether the purchase of the subscription renewal has been successful; and
rendering, by the at least one server computer, a renewal receipt available if the purchase of the subscription renewal is determined to be successful, the renewal receipt having a new expiration date, the new expiration date being later than the existing expiration date.

11. A non-transitory computer readable medium including at least computer program code tangibly stored thereon for renewing a subscription to digital content, the computer readable medium comprising:
computer program code for determining whether a previously acquired subscription to digital content needs to be renewed;
computer program code for determining whether renewal of the subscription is authorized for renewal;
computer program code for processing purchase of a subscription renewal for the subscription being renewed if determined that the subscription is authorized for renewal; and
computer program code for rendering a renewal receipt available.

12. A server computer, comprising:
at least one storage device for storing computer program code and subscription management data, the subscription management data pertaining to a plurality of customers that has purchased access to subscriptions to subscription content; and
at least one processor operatively connected to the storage device and configured to (i) determine whether a previously acquired subscription to digital content needs to be renewed for a particular customer based on the subscription management data; (ii) determine whether renewal of the subscription is authorized by the particular customer based on the subscription management data; (iii) initiate purchase of a subscription renewal for the subscription being renewed on behalf of the particular customer if determined that the subscription is authorized for renewal; and (iv) produce a renewal receipt for the subscription renewal following successful purchase of the subscription renewal for the subscription being renewed on behalf of the particular customer.

13. A computer-implemented method for acquiring digital content associated with a subscription to digital content, the method comprising:
determining whether a previously acquired subscription to digital content needs to be renewed;
receiving a renewal receipt from an online commerce server, the renewal receipt authorizing a recipient to receive subscription content for a predetermined period of time;
subsequently sending the renewal receipt to a subscription content server; and
thereafter receiving, within the predetermined period of time authorized by the renewal receipt, digital content associated with the subscription that has been successfully renewed.

14. A computer-implemented method as recited in claim 13, wherein the renewal receipt has an expiration date, and wherein the predetermined period of time is prior to the expiration date.

15. A computer-implemented method as recited in claim 13, wherein the determining of whether the previously acquired subscription needs to be renewed is based on the expiration date.

16. A computer-implemented method as recited in claim 13, wherein the renewal receipt is available to the recipient from the online commerce server after the subscription has been renewed with the online commerce server.

17. A computer-implemented method as recited in claim 13, wherein the method is performed by a client device,
wherein an application program operates on the client device and makes use of the subscription content, and
wherein the application program provides a renewal setting that enables or disables automatic renewal of the subscription by the online commerce server.

18. A computer-implemented method as recited in claim 13, wherein the renewal setting is user-controlled via interaction with the application program.

19. A non-transitory computer readable medium including at least computer program code tangibly stored thereon for acquiring digital content associated with a subscription to digital content, the computer readable medium comprising:
computer program code for determining whether a previously acquired subscription to digital content needs to be renewed;
computer program code for receiving a renewal receipt from an online commerce server, the renewal receipt authorizing a recipient to receive subscription content for a predetermined period of time;
computer program code for sending the renewal receipt to a subscription content server; and
computer program code for receiving, within the predetermined period of time authorized by the renewal receipt, digital content associated with the subscription that has been successfully renewed.

20. A computer-implemented method for distributing digital content associated with a subscription to digital content, the method comprising:
receiving, by at least one server computer, a renewal receipt from a client device, the renewal receipt authorizing the client device or its user to receive subscription content for a predetermined period of time;
verifying, by the at least one server computer, the renewal receipt received from the client device with an online commerce server that originated the renewal receipt; and
enabling, by the at least one server computer, digital content associated with the subscription to be provided to the client device if the renewal receipt is verified by the online commerce server.

21. A computer-implemented method as recited in claim 20, wherein the method further comprises:
validating the renewal receipt based on at least a digital signature provided for the renewal receipt.

22. A computer-implemented method as recited in claim 20, wherein the renewal receipt received from the client device includes an expiration date, and
wherein the method further comprises:
receiving a latest renewal receipt from the online commerce server, the latest renewal receipt including an expiration date that is later than the expiration device of the renewal receipt received from the client device.
